(19) United States
(12) Patent Application Publication
(10) Pub. No.: US 2021/0035422 A1
(43) Pub. Date: Feb. 4, 2021

(54) Methods Circuits Devices Assemblies Systems and Functionally Related Machine Executable Instructions for Selective Acoustic Sensing Capture Sampling and Monitoring

(71) Applicant: INSIGHT ACOUSTIC LTD., Herzliya (IL)

(72) Inventor: Vladimir Sherman, Tel Aviv (IL)

(21) Appl. No.: 16/790,508

(22) Filed: Feb. 13, 2020

Related U.S. Application Data
(63) Continuation-in-part of application No. 16/140,596, filed on Sep. 25, 2018, now abandoned.
(60) Provisional application No. 62/804,780, filed on Feb. 13, 2019.

(51) Int. Cl. G08B 13/16; H04R 3/00

(52) U.S. Cl. CPC G08B 13/1672; H04R 2430/20; H04R 3/005

(57) ABSTRACT

Disclosed is a system for selective acoustic sensing, capture, sampling and monitoring. One or more acoustic phase array assemblies, each including a set of microphones and digital processing circuits, wherein at least one of the phase array assemblies may include circuits to facilitate the generation of two or more acoustic beams, in the same or in different directions, concurrently. The outputs of each of the two or more acoustic beams are direction specific audio signals, wherein the direction of each direction specific audio signal corresponds to the direction of the respective beamforming process which generated that direction specific audio signal.

### RELATED APPLICATIONS SECTION

The present application claims priority from U.S. Provisional Patent Application No. 62/804,780, filed Feb. 13, 2019, which is hereby incorporated by reference in its entirety.

### FIELD OF THE INVENTION

The present invention generally relates to the fields of event detection and characterization. More specifically, the present invention relates to systems, methods, devices, assemblies, circuits and functionally associated computer executable code for physical event detection.

### BACKGROUND

A microphone, colloquially nicknamed mic or mike (/mark/), is a transducer that converts sound into an electrical signal.

Microphones are used in many applications such as telephones, hearing aids, public address systems for concert halls and public events, motion picture production, live and recorded audio engineering, sound recording, two-way radios, megaphones, radio and television broadcasting, and in computers for recording voice, speech recognition, VoIP, and for non-acoustic purposes such as ultrasonic sensors or knock sensors.

Several different types of microphone are in use, which employ different methods to convert the air pressure variations of a sound wave to an electrical signal. The most common are the dynamic microphone, which uses a coil of wire suspended in a magnetic field; the condenser microphone, which uses the vibrating diaphragm as a capacitor plate, and the piezoelectric microphone, which uses a crystal of piezoelectric material. Microphones typically need to be connected to a preamplifier before the signal can be recorded or reproduced.

Microphones are categorized by their transducer principle, such as condenser, dynamic, etc., and by their directional characteristics. Sometimes other characteristics such as diaphragm size, intended use or orientation of the principal sound input to the principal axis (end- or side-address) of the microphone are used to describe the microphone.

A microphone's directionality or polar pattern indicates how sensitive it is to sounds arriving at different angles about its central axis. Some microphone designs combine several principles in creating the desired polar pattern. This ranges from shielding (meaning diffraction/dissipation/absorption) by the housing itself to electronically combining dual membranes.

An omnidirectional (or nondirectional) microphone's response is generally considered to be a perfect sphere in three dimensions. In the real world, this is not the case. As with directional microphones, the polar pattern for an “omnidirectional” microphone is a function of frequency. The body of the microphone is not infinitely small and, as a consequence, it tends to get in its own way with respect to sounds arriving from the rear, causing a slight flattening of the polar response. This flattening increases as the diameter of the microphone (assuming it's cylindrical) reaches the wavelength of the frequency in question. Therefore, the smallest diameter microphone gives the best omnidirectional characteristics at high frequencies.

A unidirectional microphone is primarily sensitive to sounds from only one direction. The most common unidirectional microphone is a cardioid microphone, so named because the sensitivity pattern is “heart-shaped”, i.e. a cardioid. The cardioid family of microphones are commonly used as vocal or speech microphones, since they are good at rejecting sounds from other directions. In three dimensions, the cardioid is shaped like an apple centered over and around the microphone, which is the “stem” of the apple.

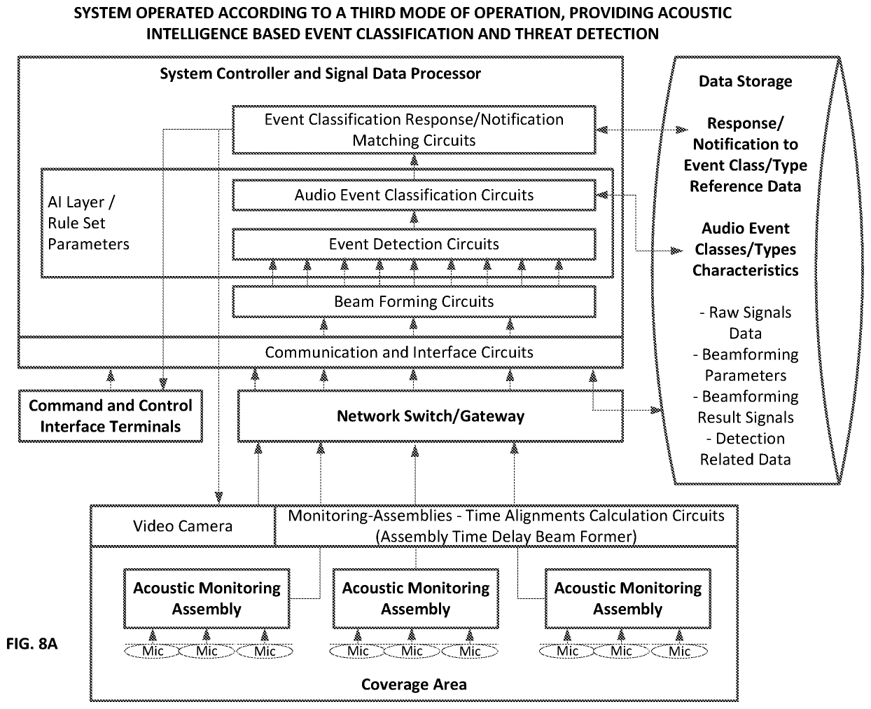

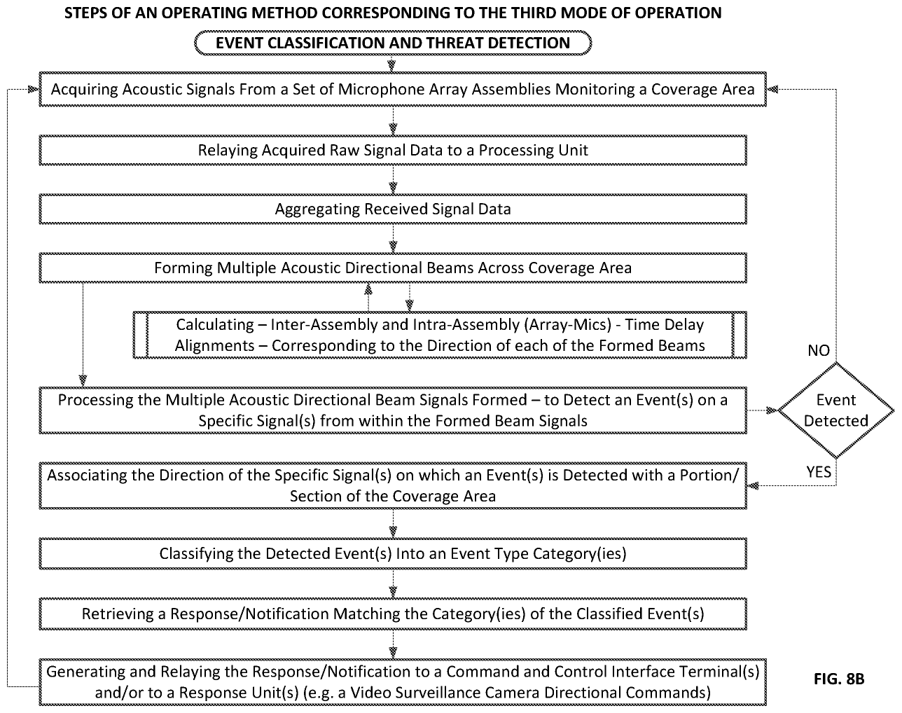

“Figure 8” or bi-directional microphones receive sound equally from both the front and back of the element.

Shotgun microphones are the most highly directional of simple first-order unidirectional types. At low frequencies they have the classic polar response of a hyper cardioid but at medium and higher frequencies an interference tube gives them an increased forward response.

Microphone Phase Array microphones are usually omnidirectional, and thus each array microphone is configured to receive acoustic signals from all directions concurrently and without directional bias. Each array microphone, therefore, when receiving acoustic signals from more than one direction at a time, superimposes all received signals onto a single electrical signal or digital data stream, depending on whether the microphone is analog or digital, and each received acoustic signals direction of arrival information is lost. Applying direction specific beamforming processes onto the outputs of at least some of the array microphones can serve to induce a directional gain on the acoustic signals which arrived from the specified direction. The output of a direction specific acoustic beamforming process, which may be performed either by dedicated beamforming circuits or by general purpose digital circuits configured to perform beamforming, is generally a direction specific or direction biased audio signal.

Selecting specific directions to apply to beamforming processes on array microphone outputs may be used to parse array captured acoustic information based on respective selected directions of arrival. Therefore, beamforming the output of a set of microphones in a specific direction can be analogized to pointing a directional microphone, with a specific directional gain and beam width, towards the specific direction and isolating the acoustic signals arriving from that specific direction from acoustic signals arriving from all other directions.

Although performing a direction specific beamforming process on the output of a microphone phase array does not generate or project an acoustic signal in the direction of the specific direction, the beamforming process is often said to “beamform” in the specific direction or to “generate an acoustic beam” in the specific direction. This beamforming or generating of an acoustic beam in reality produces a lobe of acoustic reception or a direction selective acoustic filter.

A beamformer, analog or digital, may apply a specific beamforming process associated with a given direction to signals or data output from substantially all array mics concurrently to generate a beamformed signal or data stream whose content includes acoustic information encoded on acoustic signals arriving from the given direction.

There remains a need, in the field of acoustic monitoring, for systems, methods, circuits, devices, assemblies and functionally related machine executable instructions, for acoustic monitoring of an environment, utilizing acoustic beamforming methodologies and techniques, for surveillance of acoustic targets within the monitored environment and for detection and localization of acoustic events within the environment.

### SUMMARY OF THE INVENTION

Embodiments of the present invention include methods, circuits, devices, assemblies, systems and functionally related machine executable instructions for selective acoustic sensing, capture, sampling and monitoring. According to embodiments of the present invention there may be provided one or more acoustic phase array assemblies, each including a set of microphones and digital processing circuits, wherein at least one of the phase array assemblies may include circuits to facilitate the generation of two or more acoustic beams, in the same or in different directions, concurrently. The outputs of each of the two or more acoustic beams may be direction specific audio signals, wherein the direction of each direction specific audio signal may correspond to the direction of the respective beamforming process which generated that direction specific audio signal.

Each beam can be referend to as a virtual directional microphone in describing embodiments of the present invention, as the output signal of an acoustic beam, or a data stream based thereof, may be at least partially similar to the output signal, or data stream, of a directional microphone physically oriented at a direction similar to the direction at which the acoustic beam is generated.

### Event Detection Embodiments

According to embodiments of the present invention, multiple concurrent acoustic beams from the same assembly can be used to detect specific acoustic events and to localize (estimate direction of arrival) acoustic event source.

According to embodiments of the present invention, acoustic beams concurrently generated from each of two or more different assemblies can be used to detect specific acoustic events and to localize (triangulate specific location) acoustic event source.

Detection and of specific acoustic events, and acoustic event source localization, in accordance with embodiments of the present invention, may be performed in real-time, or forensically—based on records of previously captured raw microphone data, stored in a synchronized and time stamped format.

### Speech Surveillance Embodiments

According to embodiments of the present invention, one or more acoustic beams concurrently generated from a single assembly can be used to improve/boost fidelity (signal to noise) of an acoustic signal captured from a coverage area, overlapping region or otherwise, of the one or more concurrently generated beams.

According to some embodiments, two or more beams may overlap at, or near, an acoustic target, thereby generating multiple signals corresponding to multiple ‘listening’ directions of the target, wherein the multiple signals may be summed or added to enhance their mutual, acoustic target related, components; and/or one or more beams may focus on a target while another one or more beams focus and sample background noise sources to generate noise subtraction signal, wherein background noise for subtraction may be dynamically selected.

According to embodiments of the present invention, acoustic beams concurrently generated from each of two or more assemblies can be used to improve/boost fidelity (signal to noise) of an acoustic signal captured from an overlapping region, or crossover region, of the concurrently generated beams.

Fidelity improvement and signal to noise ratio enhancement of an acoustic signal, in accordance with embodiments of the present invention, may be performed in real-time, or forensically—based on records of previously captured raw microphone data, stored in a synchronized and time stamped format.

According to some embodiments, fidelity improvement and signal to noise ratio enhancement of multiple acoustic signals, may be performed in a real-time and forensic combination, wherein a signal(s) associated with a first target is improved and/or played in real time, while signal(s) associated with at least a second target are stored in a synchronized and time stamped format for their later improvement and/or playback—based on the sored records.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

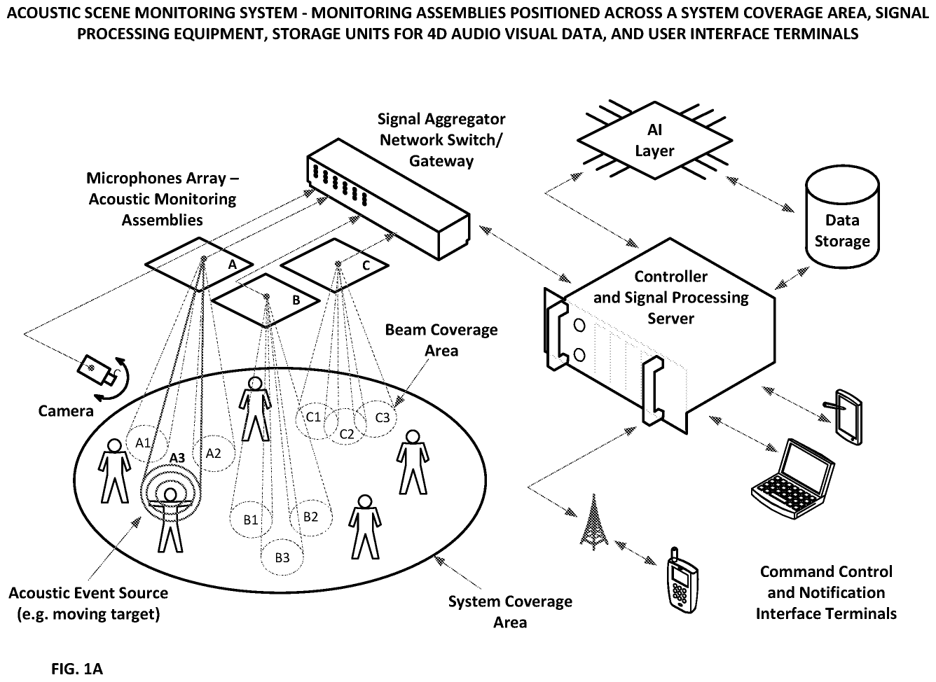

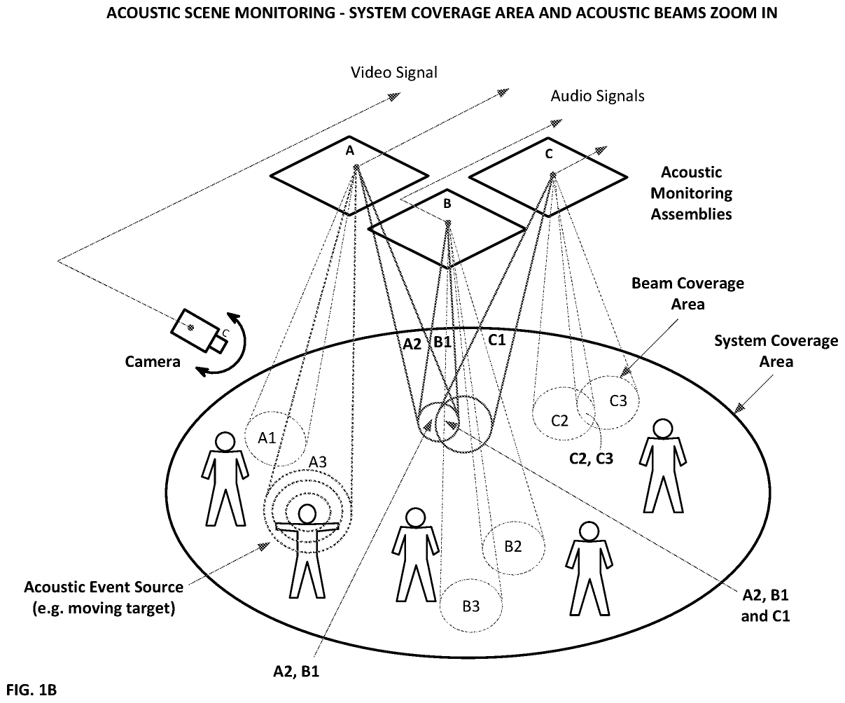

In FIG. 1A, there is shown, in accordance with some embodiments of the present invention, an acoustic scene monitoring system including a set of monitoring units positioned across a system coverage area, signal processing equipment, storage units for 4D audio visual data, and user interface terminals interconnected and operating;

In FIG. 1B, there is shown, in accordance with some embodiments of the present invention, acoustic monitoring assemblies of an acoustic scene monitoring system, and the system coverage area monitored by the assemblies;

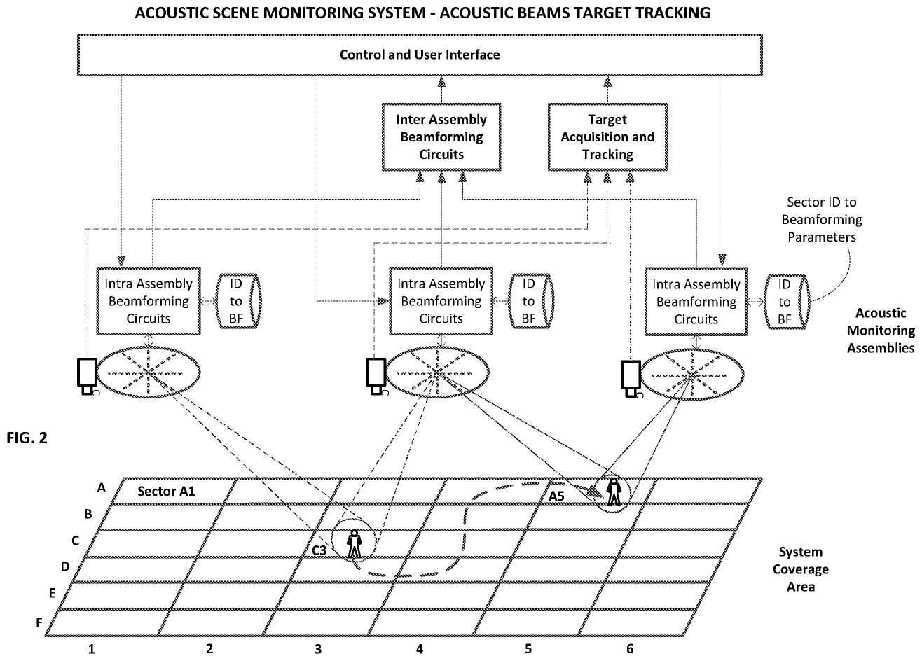

In FIG. 2, there is shown, in accordance with some embodiments of the present invention, an acoustic scene monitoring system including a set of acoustic monitoring assemblies, positioned across a system coverage area, wherein acoustic beams generated by the assemblies track a dynamic, position changing, targeted acoustic source;

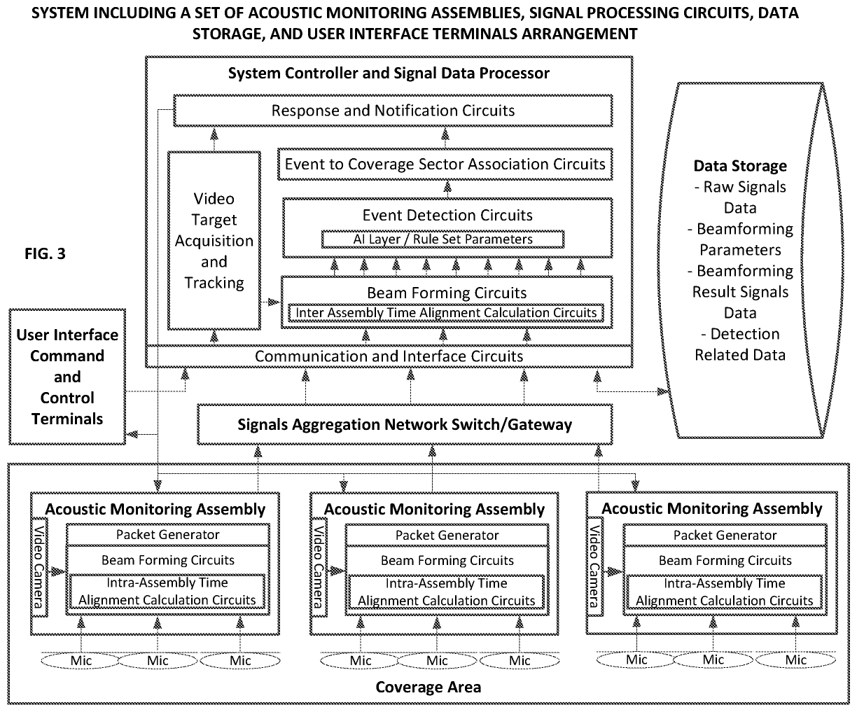

In FIG. 3, there is shown, in accordance with some embodiments of the present invention, a functional block diagram of a system including a set of acoustic monitoring units, signal processing circuits, data storage, and user interface terminals, arranged in accordance with some embodiments;

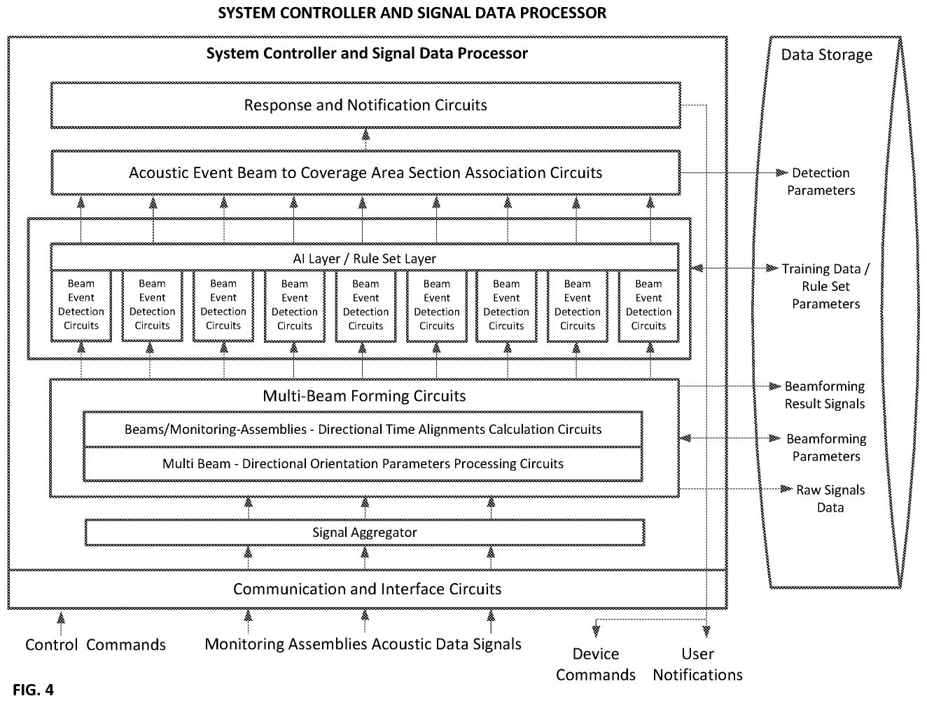

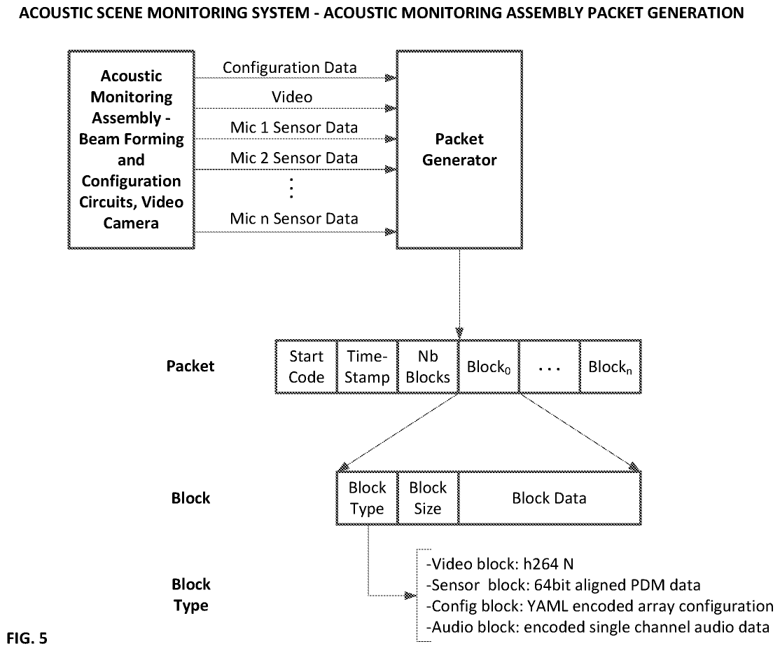

In FIG. 4, there is shown, in accordance with some embodiments of the present invention, a functional block diagram of an exemplary system controller of a system for acoustic monitoring. The controller is shown to include communication and interface circuits for receiving acoustic, and optionally video, data captured by the system's monitoring assemblies as well as control commands arriving from user interface terminals;

In FIG. 5, there is shown, in accordance with some embodiments of the present invention, a block diagram of an exemplary structure of a four dimensional (4D) audio visual data packet, including system components associated with the generation of the data packet;

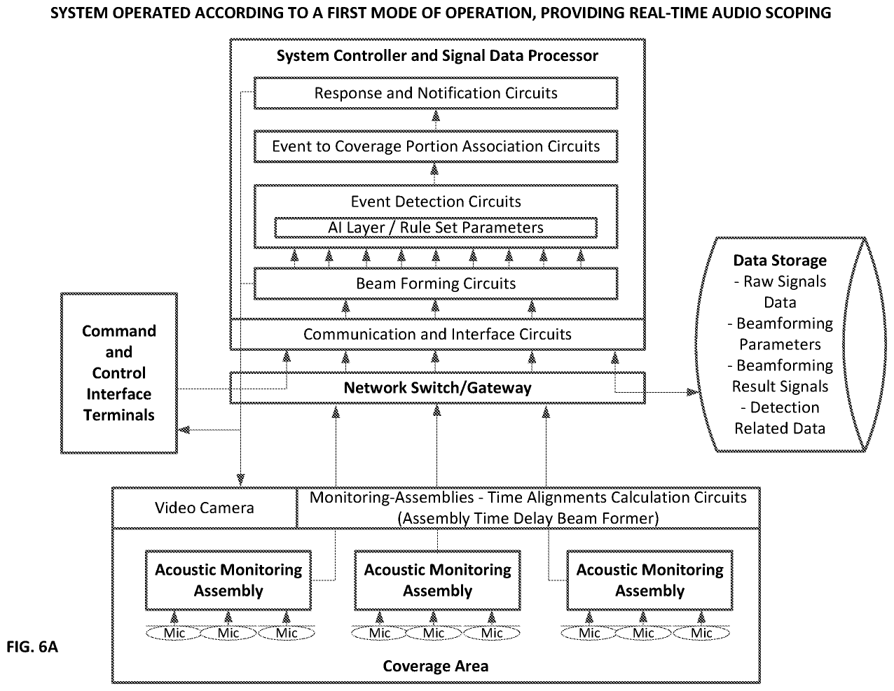

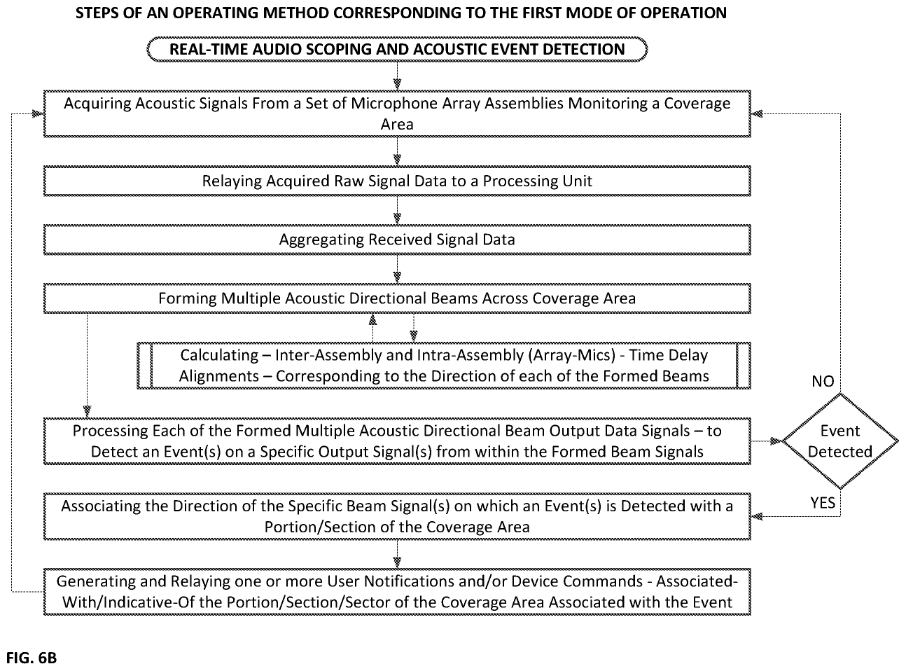

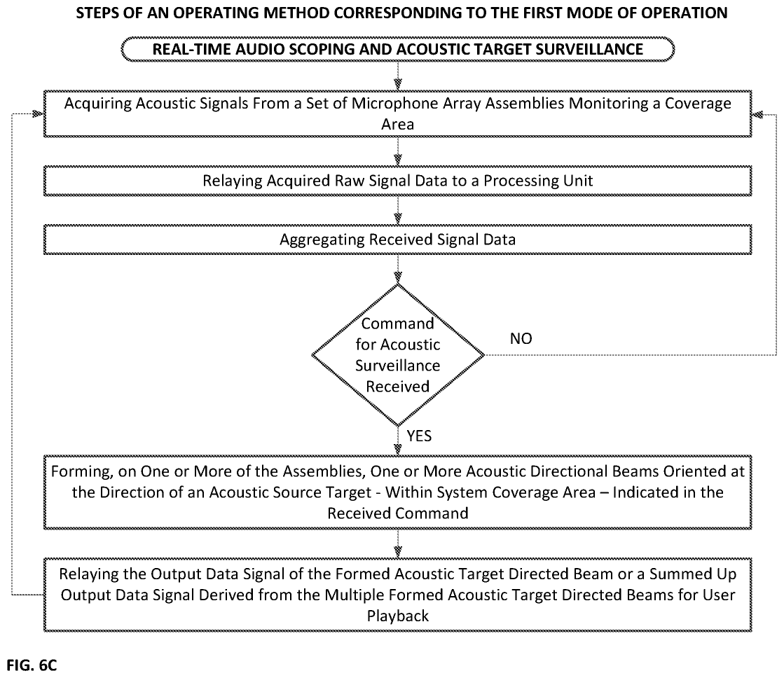

In FIG. 6A, there is shown a functional block diagram of an exemplary system operated according to a first mode of operation, providing real-time audio scoping, in accordance with embodiments of the present invention;

In FIG. 6B, there is shown a flowchart including the steps of an exemplary operating method corresponding to the first mode of operation, in accordance with embodiments of the present invention;

In FIG. 6C, there is shown a flowchart including the steps of an exemplary operating method corresponding to the first mode of operation, in accordance with embodiments of the present invention;

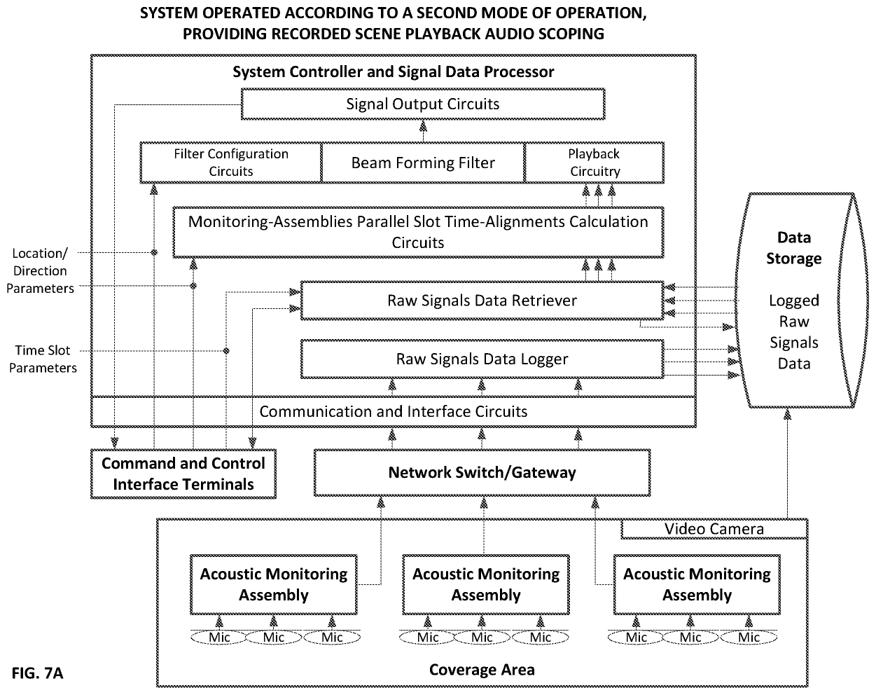

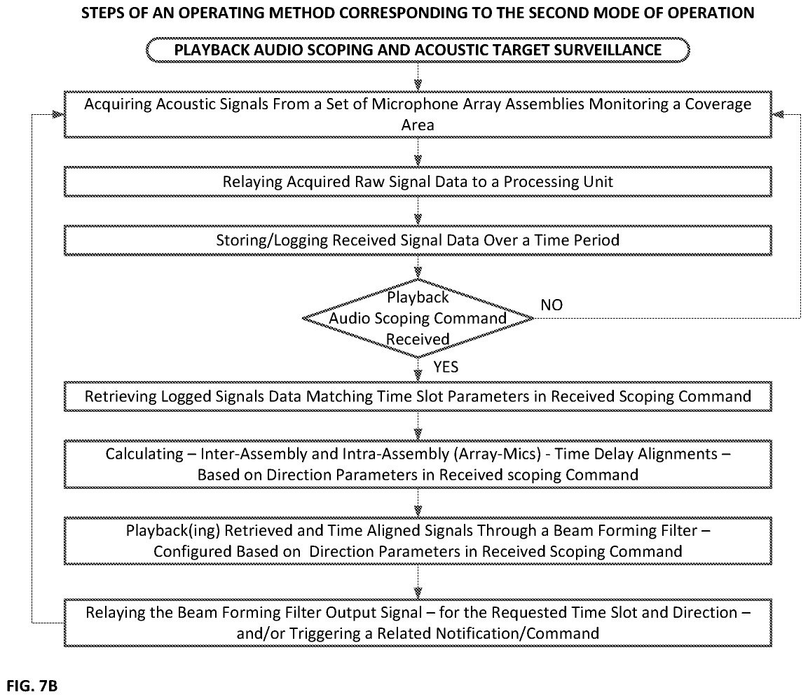

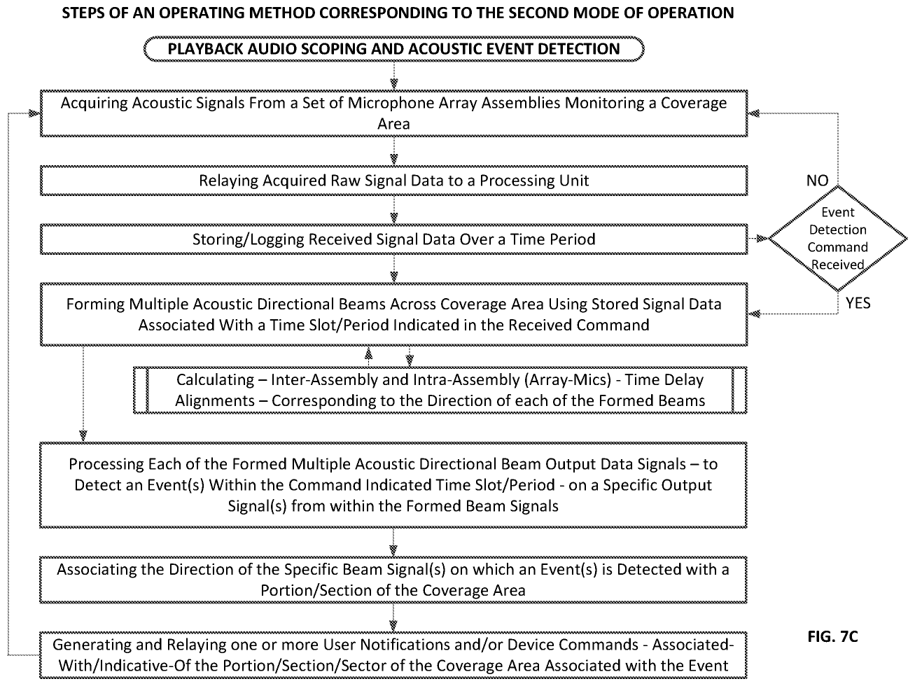

In FIG. 7A, there is shown a functional block diagram of an exemplary system operated according to a second mode of operation, providing recorded scene playback audio scoping, in accordance with embodiments of the present invention;

In FIG. 7B, there is shown a flowchart including the steps of an exemplary operating method corresponding to the second mode of operation, in accordance with embodiments of the present invention;

In FIG. 7C, there is shown a flowchart including the steps of an exemplary operating method corresponding to the second mode of operation, in accordance with embodiments of the present invention;

In FIG. 8A, there is shown a functional block diagram of an exemplary system operated according to a third mode of operation, providing acoustic intelligence based threat and event detection, in accordance with embodiments of the present invention; and

In FIG. 8B, there is shown a flowchart including the steps of an exemplary operating method corresponding to the third mode of operation, in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Functions, operations, components and/or features described herein with reference to one or more embodiments, may be combined with, or may be utilized in combination with, one or more other functions, operations, components and/or features described herein with reference to one or more other embodiments, or vice versa.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “includes”, “including”, “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to the specific embodiments illustrated by the figures or description below.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Lastly, throughout the specification, discussions utilizing terms such as “circuit”, “circuits”, “circuitry”, or the like, may refer to any type or combination of hardware, firmware and/or software based signal/data processing logic—known today, or to be devised in the future. In the following descriptions and the accompanying figures—these terms may be used interchangeably.

### SUMMARY

Embodiments of the present invention include methods, circuits, devices, assemblies, systems and functionally related machine executable instructions for selective acoustic sensing, capture, sampling and monitoring. According to embodiments of the present invention there may be provided one or more acoustic phase array assemblies, each including a set of microphones and digital processing circuits, wherein at least one of the phase array assemblies may include circuits to facilitate the generation of two or more acoustic beams, in the same or in different directions, concurrently. The outputs of each of the two or more acoustic beams may be direction specific audio signals, wherein the direction of each direction specific audio signal may correspond to the direction of the respective beamforming process which generated that direction specific audio signal.

Each beam can be referend to as a virtual directional microphone in describing embodiments of the present invention, as the output signal of an acoustic beam, or a data stream based thereof, may be at least partially similar to the output signal, or data stream, of a directional microphone physically oriented at a direction similar to the direction at which the acoustic beam is generated.

### Event Detection Embodiments

According to embodiments of the present invention, multiple concurrent acoustic beams from the same assembly can be used to detect specific acoustic events and to localize (estimate direction of arrival) acoustic event source.

According to embodiments of the present invention, acoustic beams concurrently generated from each of two or more different assemblies can be used to detect specific acoustic events and to localize (triangulate specific location) acoustic event source.

Detection and of specific acoustic events, and acoustic event source localization, in accordance with embodiments of the present invention, may be performed in real-time, or forensically—based on records of previously captured raw microphone data, stored in a synchronized and time stamped format.

### Speech Surveillance Embodiments

According to embodiments of the present invention, one or more acoustic beams concurrently generated from a single assembly can be used to improve/boost fidelity (signal to noise) of an acoustic signal captured from a coverage area, overlapping region or otherwise, of the one or more concurrently generated beams.

According to some embodiments, two or more beams may overlap at, or near, an acoustic target, thereby generating multiple signals corresponding to multiple ‘listening’ directions of the target, wherein the multiple signals may be summed or added to enhance their mutual, acoustic target related, components; and/or one or more beams may focus on a target while another one or more beams focus and sample background noise sources to generate noise subtraction signal, wherein background noise for subtraction may be dynamically selected.

According to embodiments of the present invention, acoustic beams concurrently generated from each of two or more assemblies can be used to improve/boost fidelity (signal to noise) of an acoustic signal captured from an overlapping region, or crossover region, of the concurrently generated beams.

Fidelity improvement and signal to noise ratio enhancement of an acoustic signal, in accordance with embodiments of the present invention, may be performed in real-time, or forensically—based on records of previously captured raw microphone data, stored in a synchronized and time stamped format.

According to some embodiments, fidelity improvement and signal to noise ratio enhancement of multiple acoustic signals, may be performed in a real-time and forensic combination, wherein a signal(s) associated with a first target is improved and/or played in real time, while signal(s) associated with at least a second target are stored in a synchronized and time stamped format for their later improvement and/or playback—based on the stored records.

According to some embodiments of the present invention, an acoustic scene monitoring system may include: a set of monitoring units positioned across a system coverage area, signal processing equipment, storage units for 4D audio visual data, and user interface terminals interconnected and operating.

Multiple acoustic phase array assemblies, may each include a set of microphones and digital processing circuits, wherein the phase array assemblies include circuits to facilitate the generation of two or more acoustic beams, in the same or in different directions, concurrently. The outputs of each of the acoustic beams may be direction specific audio signals, wherein the direction of each direction specific audio signal may correspond to the direction of the respective beamforming process which generated that direction specific audio signal. Each beam may be referred to as a virtual directional microphone.

According to some embodiments of the present invention, multiple concurrent acoustic beams from each of the assemblies may be used to detect specific acoustic events and/or to localize their acoustic event sources. Each of the assemblies may concurrently generate multiple acoustic beams at different directions, wherein the output of each acoustic beam is associated with direction specific audio signals. The source of an acoustic event, detected on the output signal of one of the beams, or the output signals of multiple overlapping beams generated by the same assembly, may be associated with that specific beam(s) and the direction of arrival of the acoustic signal may be calculated/estimated based thereof.

According to some embodiments, each of a one or more assemblies, may respectively generate multiple acoustic beams, wherein each of the beams has a corresponding beam coverage area within the system coverage area. The source of an acoustic event, on the acoustic signals of a beam, is associated with this beam and is thus estimated as arriving from the direction which the beam was generated at. Beams may have non-overlapping beam coverage areas, or, may partially or fully overlap with the coverage area of one or more other beams.

According to some embodiments, raw sensor data stream segments, from each of some or all of the microphones of the acoustic phase array assemblies, may be synchronized, time aligned and/or time stamped by digital processing circuits (e.g. FPGA, ASIC) at the assembly—optionally, along with respective video stream data, of the coverage area, acquired by a video camera and/or by multiple video cameras each of which is functionally associated with a respective assembly.

According to some embodiments, synchronized, time aligned and/or time stamped data may be used, by beamforming circuits at the assembly, to generate acoustic beams by introducing specific delays on data stream segments from specific microphones of the assembly, in order to realign the signals towards a specific direction. Alternatively, or additionally, synchronized, time aligned and/or time stamped data may be collectively encapsulated into data packets, wherein each packet is associated with a specific assembly and a specific time segment.

According to some embodiments, data packets may be aggregated by a signal aggregator network switch/gateway, prior to their intermittent relaying to a controller and signal processing server/module. The controller and signal processing server/module may use the relayed data to concurrently generate, substantially in real-time, a set of multiple directional acoustic beams, wherein each of the beams, or each sub set of beams, is associated with data received from a specific assembly. The controller and signal processing server/module may store the relayed data on a data storage/base for later, forensic/retroactive, beamforming, utilized for the detection and localization of prior acoustic-events and acoustic sources/targets.

According to some embodiments, an artificial intelligence (AI) layer, and/or a rule-set parameter layer, may be utilized for the detection of acoustic events on data associated with specific system generated acoustic beams. Data value sets derived from specific system generated acoustic beams, determined to be associated with an actual acoustic event, may be used as training data for the AI layer that may, for example, take the form of a convolutional neural network. The AI layer, and/or the rule-set parameter layer, may be further utilized for the classification of detected events into acoustic-event sub categories/types/clusters.

According to some embodiments, command, control and notification interface terminals—optionally in the form of general purpose computerized processing devices (e.g. smartphone, laptop) executing a client application—may be utilized by system user(s)/administrator(s) for: (1) communicating instructions for triggering/initiating the real-time, or retroactive, generation of acoustic beams by the system's assemblies and/or by the system's controller and signal processing server/module, wherein beam generation may include the communication of at least one selection of an assembly and/or at least one selection of beam direction within the system coverage area; (2) communicating stirring instructions for changing the direction at which one or more of the system generated beams are pointed; (3) receiving notifications of detected acoustic events, specific beam(s) associated with the detected events, and/or localization data associated with the source(s) of the detected acoustic event; and/or (4) inputting, outputting, sending and/or receiving—any other command, control instructions and/or user notification/information.

According to some embodiments, the command, control and notification interface terminals, may be communicatively networked with the system's controller and signal processing server/module, and/or directly with one or more of the beamforming assemblies, over: an Ethernet, a cellular, a Wi-Fi, a Bluetooth, and/or over any other computer network/connection or network/connection combination.

According to some embodiments, acoustic beams concurrently generated from each of two or more different assemblies may be used to detect specific acoustic events and to localize an acoustic event source. The source of an acoustic event, detected on the output signals of multiple overlapping beams concurrently generated by each of two or more different assemblies, may be associated with those specific beam(s) and the directions of arrival of each of the acoustic signals—to its respective assembly—may be calculated/estimated based thereof. The multiple directions of arrival—to/towards the two or more respective different assemblies—are collectively used for triangulating the specific location of the acoustic source, at the overlapping/crossing/nearing/crossover point/area/region of two or more of the multiple directions of arrival.

According to some embodiments, acoustic beams generated by different assemblies may generate: a complete overlap of beams coverage area of two or more beams, a partial overlap of beams coverage area of two or more beams, or any combination of a complete and partial overlap of beams coverage area of three or more beams. An acoustic source detected on two or more overlapping beams output signals may be specifically located by triangulating the directions of arrival of the two or more beams.

According to some embodiments of the present invention, one or multiple concurrent acoustic beams from one or more of the assemblies may be used for speech/sound surveillance of specific acoustic source(s) targeted. One or more of the assemblies may generate an acoustic beam, or multiple concurrent acoustic beams at different directions, wherein the output of specific acoustic beam(s) may be selected for generating, and ‘listening’ to, direction specific audio signals associated with the direction of the selected beam(s).

According to some embodiments, a targeted acoustic source, at which direction an acoustic beam—or multiple overlapping beams generated by the same assembly and/or by different assemblies—may be generated or stirred, may be selected: (1) based on an acoustic event detection within the system coverage area and the localization of its source, as described herein; (2) based on the referencing of specific prior data records of acoustic sources, and the matching of direction specific audio signals data, being acquired within the system coverage area, thereto; (3) based on the receipt of user selections of specific acoustic sources viewable in a video stream of the system coverage area being presented to the user (e.g. user touchscreen selection of an object/person viewable in the presented video); and/or (4) based on optically tracking the position of a preselected audio source, as the direction of arrival of its acoustic signal, changes—while the acoustic beam(s) direction(s) are intermittently recalculated/re-estimated to continuously ‘listen’ in the direction of the acoustic source, based on its optically tracked position.

According to some embodiments, one or more assemblies may generate multiple acoustic beams, wherein each of the beams has a corresponding beam coverage area within the system coverage area. The acoustic signals data, associated with signals arriving from the direction a given beam is generated at, may correspond to the direction of the indicated acoustic source, which was selected for surveillance/‘listening’. The acoustic signals data of the selected acoustic source, may be communicated for user presentation/playing/playback, voice/sound recognition/identification analysis and/or storage for later playback/analysis/reference/matching. Some or all of the generated beams may have non-overlapping beam coverage areas; some or all of the generated beams may have partially overlapping coverage areas; and/or some or all of the generated beams may have completely overlapping coverage areas (substantially the same coverage area).

According to some embodiments, raw sensor data stream segments, from each of some or all of the microphones of one or more of the acoustic phase array assemblies, may be synchronized, time aligned and/or time stamped by digital processing circuits (e.g. FPGA, ASIC) at the assembly—optionally, along with respective video stream data segment, of the coverage area, acquired by a video camera and/or by multiple video cameras each of which is functionally associated with a respective assembly.

According to some embodiments, synchronized, time aligned and/or time stamped data may be used, by beamforming circuits at each of the assembly, to generate acoustic beams by introducing specific delays on data stream segments from specific microphones of the assembly, in order to realign the signals towards a specific direction of an acoustic source(s) selected for surveillance/‘listening’. Alternatively, or additionally, synchronized, time aligned and/or time stamped data may be collectively encapsulated into data packets, wherein each packet may be associated with a specific assembly and a specific time segment.

According to some embodiments, Data packets may be aggregated by a signal aggregator network switch/gateway, prior to their intermittent relaying to the system's controller and signal processing server/module. The controller and signal processing server/module may use the relayed data to generate, substantially in real-time, an acoustic directional beam, or a set of multiple concurrent directional acoustic beams—directed at an acoustic source(s) selected/targeted for surveillance/‘listening’—wherein each of the beams, or each sub set of beams, may be associated with data received from a specific assembly. The controller and signal processing server/module may store the relayed data on the data storage/base for later, forensic/retroactive, beamforming utilized for the surveillance-of/‘listening’-to previous sounds/voices made by selected acoustic source(s).

According to some embodiments, an artificial intelligence (AI) layer, and/or a rule-set parameter layer, may be utilized for processing of generated acoustic beam output signals and/or data streams derived therefrom, wherein processing may for example include: (1) analysis—for example feature extraction such as identification of place and person names; (2) assessment—for example speaker mood or physical/psychological condition recognition; and/or (3) matching—for example speaker or sound making device identification by reference of, and comparison to, voice/sound database/repository records.

According to some embodiments, data value sets derived from system generated acoustic beams (or form other acoustic information sources), determined to be associated with specific acoustic source features, types and/or categories, may be used as training data for the AI layer that may, for example, take the form of a convolutional neural network.

According to some embodiments, command, control and notification interface terminals—optionally in the form of general purpose computerized processing devices (e.g. smartphone, laptop) executing a client application—may be utilized by system user(s)/administrator(s) for: (1) communicating instructions for triggering/initiating the real-time, or retroactive, generation of acoustic beams by the system's assemblies and/or by the system's controller and signal processing server/module, wherein beam generation may include the communication of at least one selection of an acoustic source within the system coverage area—selected using any of the forms/methodologies described herein; (2) communicating acoustic source tracking instructions (e.g. track for 30 seconds, track until acoustic signal stops/weakens, track until leaves coverage area or specific section(s) thereof) for stirring/changing the direction at which one or more of the system generated beams are pointed; (3) receiving, regenerating (e.g. converting digital data stream to acoustic signal) and outputting (e.g. playing, play-backing) acoustic signals from acoustic sources currently, or retroactively, under surveillance/‘listening’ by specific system generated acoustic beam(s); and/or (4) inputting, outputting, sending and/or receiving—any other command, control instructions and/or user notification/information.

According to some embodiments, the command, control and notification interface terminals, may be communicatively networked with the system's controller and signal processing server/module, and/or directly with one or more of the beamforming assemblies, over: an Ethernet, a cellular, a Wi-Fi, a Bluetooth, and/or over any other computer network/connection or network/connection combination.

According to some embodiments, acoustic beams concurrently generated from each of two or more different assemblies may be used to improve/boost the fidelity (signal-to-noise ratio—S/N) of an acoustic signal, or a data stream representation thereof, captured from a coverage area of two or more concurrently generated beams.

According to some embodiments, signal outputs of two or more beams having an overlapping coverage area may be compared, wherein similar components in the signals—representing different directions-of-arrival/projections of the same acoustic source being surveyed/‘listened-to’/targeted—may be summed up, or otherwise collectively joined/considered, to improve the quality of, and/or boost, the signal associated with the surveyed/‘listened-to’/targeted acoustic source.

According to some embodiments, signal outputs of a first set of one or more beams may be directed/focused at the same acoustic source being surveyed/‘listened-to’/targeted, while a second set of one or more other beams may be directed/focused at other directions, optionally in the vicinity/proximity of the acoustic source, to sample background noise sources. Sampled background noise sources of the second set of beams may be subtracted from signal outputs of the first set of beams, thereby reducing the amount of noise and improving the S/N ratio of the generated acoustic source signal.

According to some embodiments, acoustic beams generated by different assemblies may generate a complete coverage area overlap, and/or a partial overlap of a beam two or more other beams.

According to some embodiments, acoustic signals captured from a coverage area of two or more beams may be summed up, or otherwise collectively joined/considered, to improve the quality of, and/or boost, the signal associated with the surveyed/‘listened-to’ acoustic source located at the coverage area. Alternatively, or in addition, any one or more other beams may be used to sample noise coming from the direction at which it is oriented, wherein the sampled noise signal(s) may be subtracted from the summed up signal of the two or more summed up beams and/or a beam subset signal combination/sum thereof.

### FIGURES DESCRIPTION

According to some embodiments of the present invention, an acoustic scene monitoring system may include: a set of monitoring units positioned across a system coverage area, signal processing equipment, storage units for 4D audio visual data, and user interface terminals interconnected and operating.

Multiple acoustic phase array assemblies, may each include a set of microphones and digital processing circuits, wherein the phase array assemblies include circuits to facilitate the generation of two or more acoustic beams, in the same or in different directions, concurrently. The outputs of each of the acoustic beams may be direction specific audio signals, wherein the direction of each direction specific audio signal may correspond to the direction of the respective beamforming process which generated that direction specific audio signal. Each beam may be referred to as a virtual directional microphone.

Reference is now made to FIG. 1A, where there is shown, in accordance with some embodiments of the present invention, multiple concurrent acoustic beams from each of the assemblies that may be used to detect specific acoustic events and to localize their acoustic event sources. In the figure, each of the assemblies is shown to concurrently generate multiple acoustic beams at different directions, wherein the output of each acoustic beam is associated with direction specific audio signals. The source of an acoustic event, detected on the output signal of one of the beams, or the output signals of multiple overlapping beams generated by the same assembly, is associated with that specific beam(s) and the direction of arrival of the acoustic signal is calculated/estimated based thereof.

In the exemplary figure, each of the three assemblies shown A, B and C, respectively generates three acoustic beams—A1, A2 and A3; B1, B2 and B3; and C1, C2 and C3—wherein each of the beams has a corresponding beam coverage area within the system coverage area. The source of an acoustic event, indicated in the figure as being detected on the acoustic signals of beam A3, is associated with this beam and is thus estimated as arriving from the direction which beam A3 was generated at. Beams A1, A2 and A3; and beams B1, B2 and B3; are shown to have non-overlapping beam coverage areas, whereas the coverage areas of beams C1 and C3 are shown to partially overlap with the coverage area of beam C2.

Raw sensor data stream segments, from each of some or all of the microphones of the acoustic phase array assemblies, may be synchronized, time aligned and/or time stamped by digital processing circuits (e.g. FPGA, ASIC) at the assembly—optionally, along with respective video stream data, of the coverage area, acquired by the shown video camera and/or by multiple video cameras each of which is functionally associated with a respective assembly.

Synchronized, time aligned and/or time stamped data may be used, by beamforming circuits at the assembly, to generate acoustic beams by introducing specific delays on data stream segments from specific microphones of the assembly, in order to realign the signals towards a specific direction. Alternatively, or additionally, synchronized, time aligned and/or time stamped data may be collectively encapsulated into data packets, wherein each packet is associated with a specific assembly and a specific time segment.

Data packets may be aggregated by the shown signal aggregator network switch/gateway, prior to their intermittent relaying to the controller and signal processing server/module. The controller and signal processing server/module may use the relayed data to concurrently generate, substantially in real-time, a set of multiple directional acoustic beams, wherein each of the beams, or each sub set of beams, is associated with data received from a specific assembly. The controller and signal processing server/module may store the relayed data on the shown data storage/base for later, forensic/retroactive, beamforming utilized for the detection and localization of prior acoustic-events and acoustic sources.

The shown artificial intelligence (AI) layer, and/or a rule-set parameter layer, may be utilized for the detection of acoustic events on data associated with specific system generated acoustic beams. Data value sets derived from specific system generated acoustic beams, determined to be associated with an actual acoustic event, may be used as training data for the AI layer that may, for example, take the form of a convolutional neural network. The AI layer, and/or the rule-set parameter layer, may be further utilized for the classification of detected events into acoustic-event sub categories/clusters.

The shown command, control and notification interface terminals—optionally in the form of general purpose computerized processing devices (e.g. smartphone, laptop) executing a client application—are utilized by system user(s)/administrator(s) for: (1) communicating instructions for triggering/initiating the real-time, or retroactive, generation of acoustic beams by the system's assemblies and/or by the system's controller and signal processing server/module, wherein beam generation may include the communication of at least one selection of an assembly and at least one selection of beam direction within the system coverage area; (2) communicating stirring instructions for changing the direction at which one or more of the system generated beams are pointed; (3) receiving notifications of detected acoustic events, specific beam(s) associated with the detected events, and/or localization data associated with the source(s) of the detected acoustic event; and/or (4) inputting, outputting, sending and/or receiving—any other command, control instructions and/or user notification/information.

The command, control and notification interface terminals, may be communicatively networked with the system's controller and signal processing server/module, and/or directly with one or more of the beamforming assemblies, over: an Ethernet, a cellular, a Wi-Fi, a Bluetooth, and/or over any other computer network/connection or network/connection combination.

According to some embodiments, acoustic beams concurrently generated from each of two or more different assemblies can be used to detect specific acoustic events and to localize an acoustic event source. The source of an acoustic event, detected on the output signals of multiple overlapping beams concurrently generated by each of two or more different assemblies, is associated with those specific beam(s) and the directions of arrival of each of the acoustic signals—to its respective assembly—is calculated/estimated based thereof. The multiple directions of arrival—to/towards the two or more respective different assemblies—are collectively used for triangulating the specific location of the acoustic source, at the overlapping/crossing/nearing point/area of two or more of the multiple directions of arrival.

Reference is now made to FIG. 1B, where there is shown, in accordance with some embodiments of the present invention, acoustic monitoring assemblies of an acoustic scene monitoring system, and the system coverage area monitored by the assemblies. In the exemplary figure, acoustic beams A2, B1 and C1, respectfully generated by different assemblies A, B and C, are shown to generate a complete overlap of beams A2 and B1, labeled ‘A2, B1’; and a partial overlap of Beam C1 with, both, beams A2 and B1, labeled ‘A2, B1 and C1’. An acoustic source detected on two of, or all three of, output signals A2, B1, and C1, may be specifically located by triangulating the directions of arrival of beams: A2 and B1; A2 and C1; B1 and C1; and/or A2, B1 and C1.

According to some embodiments, multiple concurrent acoustic beams from each of the assemblies may be used for speech/sound surveillance of specific acoustic sources. Returning to FIG. 1A, each of the assemblies is shown to concurrently generate multiple acoustic beams at different directions, wherein the output of specific acoustic beam(s) may be selected for generating, and ‘listening’ to, direction specific audio signals associated with the direction of the selected beam(s).

An acoustic source, at which direction an acoustic beam—or multiple overlapping beams generated by the same assembly and/or by different assemblies—is to be generated or stirred, may be selected: (1) based on an acoustic event detection within the system coverage area and the localization of its source, as described herein; (2) based on the referencing of specific prior data records of acoustic sources, and the matching of direction specific audio signals data, being acquired within the system coverage area, thereto; (3) based on the receipt of user selections of specific acoustic sources viewable in a video stream of the system coverage area being presented to the user (e.g. user touchscreen selection of an object/person viewable in the presented video); and/or (4) based on optically tracking the position of a preselected audio source, as the direction of arrival of its acoustic signal, changes—while the acoustic beam(s) direction(s) are intermittently recalculated/re-estimated to continuously ‘listen’ in the direction of the acoustic source, based on its optically tracked position.

In the exemplary figure, each of the three assemblies shown A, B and C, respectively generates three acoustic beams—A1, A2 and A3; B1, B2 and B3; and C1, C2 and C3—wherein each of the beams has a corresponding beam coverage area within the system coverage area. The acoustic signals data, associated with signals arriving from the direction that beam A3 is generated at, corresponds to the direction of the indicated acoustic source, which was selected for surveillance/‘listening’. The acoustic signals data of the selected acoustic source, may be communicated for user presentation/playing/playback, voice/sound recognition/identification analysis and/or storage for later playback/analysis/reference/matching.

Beams A1, A2 and A3; and beams B1, B2 and B3; are shown to have non-overlapping beam coverage areas, whereas the coverage areas of beams C1 and C3 are shown to partially overlap with the coverage area of beam C2.

Raw sensor data stream segments, from each of some or all of the microphones of the acoustic phase array assemblies, may be synchronized, time aligned and/or time stamped by digital processing circuits (e.g. FPGA, ASIC) at the assembly—optionally, along with respective video stream data, of the coverage area, acquired by the shown video camera and/or by multiple video cameras each of which is functionally associated with a respective assembly.

Synchronized, time aligned and/or time stamped data may be used, by beamforming circuits at the assembly, to generate acoustic beams by introducing specific delays on data stream segments from specific microphones of the assembly, in order to realign the signals towards a specific direction of an acoustic source(s) selected for surveillance/‘listening’. Alternatively, or additionally, synchronized, time aligned and/or time stamped data may be collectively encapsulated into data packets, wherein each packet is associated with a specific assembly and a specific time segment.

Data packets may be aggregated by the shown signal aggregator network switch/gateway, prior to their intermittent relaying to the controller and signal processing server/module. The controller and signal processing server/module may use the relayed data to generate, substantially in real-time, an acoustic directional beam, or a set of multiple concurrent directional acoustic beams—directed at an acoustic source(s) selected for surveillance/‘listening’—wherein each of the beams, or each sub set of beams, is associated with data received from a specific assembly. The controller and signal processing server/module may store the relayed data on the shown data storage/base for later, forensic/retroactive, beamforming utilized for the surveillance-of/‘listening’-to previous sounds/voices made by selected acoustic source(s).

The shown artificial intelligence (AI) layer, and/or a rule-set parameter layer, may be utilized for processing of generated acoustic beam output signals and/or data streams derived therefrom, wherein processing includes: (1) analysis—for example feature extraction such as identification of place and person names; (2) assessment—for example speaker mood or physical/psychological condition recognition; and/or (3) matching—for example speaker or sound making device identification by reference of, and comparison to, voice/sound database/repository records.

Data value sets derived from system generated acoustic beams (or form other acoustic information sources), determined to be associated with specific acoustic source features, may be used as training data for the AI layer that may, for example, take the form of a convolutional neural network.

The shown command, control and notification interface terminals—optionally in the form of general purpose computerized processing devices (e.g. smartphone, laptop) executing a client application—are utilized by system user(s)/administrator(s) for: (1) communicating instructions for triggering/initiating the real-time, or retroactive, generation of acoustic beams by the system's assemblies and/or by the system's controller and signal processing server/module, wherein beam generation may include the communication of at least one selection of an acoustic source within the system coverage area—selected using any of the forms/methodologies described herein; (2) communicating acoustic source tracking instructions (e.g. track for 30 seconds, track until acoustic signal stops/weakens, track until leaves coverage area or specific section(s) thereof) for stirring/changing the direction at which one or more of the system generated beams are pointed; (3) receiving, regenerating (e.g. converting digital data stream to acoustic signal) and outputting (e.g. playing, play-backing) acoustic signals from acoustic sources currently, or retroactively, under surveillance/‘listening’ by specific system generated acoustic beam(s); and/or (4) inputting, outputting, sending and/or receiving—any other command, control instructions and/or user notification/information.

The command, control and notification interface terminals, may be communicatively networked with the system's controller and signal processing server/module, and/or directly with one or more of the beamforming assemblies, over: an Ethernet, a cellular, a Wi-Fi, a Bluetooth, and/or over any other computer network/connection or network/connection combination.

According to some embodiments, acoustic beams concurrently generated from each of two or more different assemblies can be used to improve/boost the fidelity (signal-to-noise ratio—S/N) of an acoustic signal captured from a coverage area of one or more of the two or more concurrently generated beams.

According to some embodiments, signal outputs of two or more beams having an overlapping coverage area may be compared, wherein similar components in the signals—representing different directions-of-arrival/projections of the same acoustic source being surveyed/‘listened-to’—may be summed up, or otherwise collectively joined/considered, to improve the quality of, and/or boost, the signal associated with the surveyed/‘listened-to’ acoustic source.

According to some embodiments, signal outputs of a first set of one or more beams may be directed/focused at the same acoustic source being surveyed/‘listened-to’, while a second set of one or more other beams may be directed/focused at other directions, optionally in the vicinity/proximity of the acoustic source, to sample background noise sources. Sampled background noise sources of the second set of beams may be subtracted from signal outputs of the first set of beams, thereby reducing the amount of noise and improving the S/N ratio of the acoustic source.

Returning to FIG. 1B, there is shown, in accordance with some embodiments of the present invention, acoustic monitoring assemblies of an acoustic scene monitoring system, and the system coverage area monitored by the assemblies. In the exemplary figure, acoustic beams A2, B1 and C1, respectfully generated by different assemblies A, B and C, are shown to generate a complete overlap of beams A2 and B1, labeled ‘A2, B1’; and a partial overlap of Beam C1 with, both, beams A2 and B1, labeled ‘A2, B1 and C1’.

Acoustic signals captured from the coverage area of two of, or all three of, output signals A2, B1, and C1, is summed up, or otherwise collectively joined/considered, to improve the quality of, and/or boost, the signal associated with the surveyed/‘listened-to’ acoustic source located at the coverage area. Alternatively, or in addition, any one or more of the other beams shown in the figure—A1, A3, B2, B3, C2 and C3—is used to sample noise coming from the direction at which it is oriented, wherein the sampled noise signal(s) are subtracted from the signal outputs of A2, B1, C1 and/or any combination/sum thereof.

Reference is now made to FIG. 2, where there is shown, in accordance with some embodiments of the present invention, an acoustic scene monitoring system including a set of acoustic monitoring assemblies, positioned across a system coverage area, wherein acoustic beams generated by the assemblies track a dynamic, position changing, targeted acoustic source.

In the figure, the system coverage area is shown to be divided into sectors by a grid, wherein each sector is identified by a letter—A-F—indicative of a specific row of the grid, and by a number—1-6—indicative of a specific column of the greed. Each of the acoustic monitoring assemblies shown, includes: a microphone array, intra assembly beamforming circuits, a video camera and a ‘sector identification (ID) to beamforming parameters’ records database.

Video streams from each of the video cameras are relayed to the shown target acquisition and tracking unit, where potential acoustic source targets are optically detected, acquired and tracked along following video stream images. The video stream is then relayed for user presentation to the control and user interface. User selection(s) (e.g. touchscreen selections on displayed video) are associated with a corresponding tracked acoustic source target(s), and the system coverage area sector(s) ID(s) at which the target has been detected are relayed to the intra assembly beamforming circuits of some or all of the assemblies.

The intra assembly beamforming circuits use the received system coverage area sector(s) ID(s) to reference the ‘sector ID to beamforming parameters’ records database, retrieve parameters matching the sector ID(s), and generate directional acoustic beams based thereof, wherein beam generation includes target-direction dependent time alignment of microphones of the same assembly. Acoustic beam signal outputs, or data streams representing same, are relayed to the inter assembly beamforming circuits where beams signals/data-streams, of beams from different assemblies directed at the same target, are time aligned in accordance with the relative position and direction of the tracked target to the assemblies. Time aligned beams signals/data-streams are then relayed to the control and user interface for playing/playback to the user.

As the position of the tracked target in the video camera stream(s) changes over time, the new system coverage area sector(s) at which the target is positioned is relayed to the assemblies for intermittently stirring/reforming/changing-the-direction of the beam(s) based thereof.

In the exemplary figure, an acoustic source target (voice making subject) is shown to be initially positioned at sector C3 of the system's coverage area, while acoustic beams—generated based on the relative direction of their generating assembly to sector C3—from each of the two assemblies on the left side, are directed thereat. As the acoustic source target (voice making subject) changes its position sector, moving along the dotted line, the directions of the beams directed thereat likewise changes. At the final, sector A5 position, the generation of the acoustic beam by the left assembly has been halted, the beam generated by the center assembly has been stirred towards sector A5, and the another beam, generated by the right assembly, has been initiated and likewise directed at sector A5.

Reference is now made to FIG. 3, where there is shown, in accordance with some embodiments of the present invention, a functional block diagram of a system including a set of acoustic monitoring units, signal processing circuits, data storage, and user interface terminals, arranged in accordance with some embodiments.

In the figure, there are shown multiple acoustic monitoring assemblies positioned within a system coverage area. Each of the assemblies includes: a set of microphones, a video camera, beam forming circuits comprising an intra-unit time alignment calculation circuits and a packet generator.

Audio signals, acquired by the microphones of a given assembly, are converted to a digital data stream. The digital raw data streams of each of the microphones, or specific time segments thereof, are time aligned in relation to each other and in relation to a video data stream received from the video camera, by the intra-unit time alignment calculation circuits. Video camera and microphones time aligned raw data streams segments, associated with the same time period, are collectively packetized into the same data packet by the packet generator.

Alternatively, or additionally, video camera and microphones data streams segments, are time aligned, by the intra-unit time alignment calculation circuits, in relation to a specific acoustic signal arrival direction, to compensate for the lateness of arrival of the acoustic signal, arriving from the specific direction selected, to some of the assembly's microphones—thereby generating an acoustic beam, or virtual directional microphone, oriented in the selected direction. Video camera and microphones direction-specific time aligned data streams segments, associated with the same time period, are collectively packetized into the same data packet by the packet generator. Multiple sets of video camera and microphones direction-specific time aligned data streams segments, each associated with a different direction, may be concurrently generated by the intra-unit time alignment calculation circuits of a single assembly.

Generated data packets are aggregated by the shown signals aggregation network switch/gateway, prior to their intermittent communication/relaying to the communication and interface circuits of the system controller and signal processor. Received packets data is used by the beam forming circuits to generate further direction-specific acoustic beams from data associated with the video and microphone streams of any specific assembly or multiple specific assemblies.

The shown inter-unit time alignment calculation circuits is used to time align sets of direction-specific video and microphone data streams segments, originating from different assemblies, wherein the direction-specific video and microphone data streams segments sets of each of the assemblies are: aligned at a substantially similar direction, directed at the same acoustic source, and/or overlap or cross each other. Inter-unit time alignment is used to compensate for the lateness of arrival of the acoustic signal, arriving from the specific direction selected, to some of the assemblies.

Multiple generated direction-specific acoustic beams output data streams, are relayed the event detection circuits, wherein each stream is analyzed/examined for indication of an acoustic event. The ‘AI layer/rule set parameters layer’ may, for example, indicate an acoustic event upon one or more data stream values of a given acoustic beam output data stream: crossing one or more threshold values indicated by the rule set parameters and/or determined to match an acoustic event scenario previously learned-by/taught-to/provided-as-training-to the AI layer.

The event to coverage sector association circuits correlates the directional parameters of the acoustic beam on which an acoustic event has been detected to a specific sector of the system's coverage area, thereby estimating/determining the location/position within the coverage area at which the detected acoustic event occurred. The location/position (e.g. coverage area sector) of the acoustic event is then relayed to the response and notification circuits for: generating event location/position related notification(s) and communicating them for presentation/output on one or more of the user interface command and control terminals; communicating the acoustic data stream, associated with the acoustic beam directed at the detected event, at or around the time of the event, for playback on one or more of the user interface command and control terminals; communicating beamforming parameters associated with the location/position of the detected event back to one or more of the monitoring assemblies, for them to generate additional or other beams directed at the location/position of the event or its proximity; and/or communicating instructions or commands to direct one or more external systems/components (e.g. camera, physical directional microphone, speaker, light source, weapon) to/towards/at-the-direction of the location/position of the detected event.

The user interface command and control terminals are further used by system users for inputting beam forming direction indicative parameters, for example, by specifically selecting a subject, an object and/or a location within the coverage area, indicating/pointing (e.g. touchscreen selecting, mouse pointer selecting) their location over a user terminal displayed video stream of the coverage area.

The shown video target acquisition and tracking circuits analyze the video streams data acquired from the coverage area by the video cameras of the monitoring assemblies. Analysis results are utilized to: detect potential acoustic source targets within the video streams data and derive their characteristics and position; track detected dynamic acoustic source targets by intermittently reanalyzing later/current video stream segments to recognize the previously detected targets; derive the updated location of the targets; and/or relay/communicate the initial and/or updated target positions to the beam forming circuits of: the system controller and data processor, one or more of the assemblies, or both—for stirring generated beams and/or generating new beams, directed at the up to date positions of the targets.

The data storage module shown in the figure is written-to/updated and referenced by the system controller and signal data processor and/or directly by the acoustic monitoring assemblies. The data storage includes data records relating to: raw acoustic signals data—as received from the monitoring assemblies; beamforming parameters generated—based on user target selections, locations of detected acoustic events and/or system rule-based/AI-based beam generation or stirring decisions; beamforming result signals data—as provided by monitoring assemblies', or system controller and signal data processor's, beamforming circuits; and/or detection related data—indicative of locations/positions of system detected acoustic event sources.

Reference is now made to FIG. 4, where there is shown, in accordance with some embodiments of the present invention, a functional block diagram of an exemplary system controller of a system for acoustic monitoring. The controller is shown to include communication and interface circuits for receiving acoustic, and optionally video, data captured by the system's monitoring assemblies as well as control commands arriving from user interface terminals.

The data, received as data packets, each including multiple time aligned audio data stream segments, and a video stream segment time aligned therewith, from a specific monitoring assembly. Data packets are aggregated at the signal aggregator and un-packetized to chronologically regenerate the data streams generated by each of the system assemblies. The multi-beam forming circuits stores the raw regenerated data to the shown data storage. Beam forming parameters—received from user interface terminals and/or system generated—are referenced and processed by the multi beam directional orientation parameters processing circuits, and relayed to the monitoring assemblies directional time alignments calculation circuits for generating multiple acoustic beams, direction oriented based on the parameters, from each of the assemblies' regenerated data streams, wherein one or more beams are generated from each of the assemblies' data streams. Generated acoustic beams outputs are stored to the shown data storage.

The acoustic beams output data streams, are fed, in parallel, to multiple respective beam event detection circuits. Each beam event detection circuit monitors an acoustic beam output data stream—to detect a data value, or a data values combination—matching one or more ‘acoustic event’ detection conditions, as defined by the rule-set layer's parameters, and/or regarded/classified by the AI layer as such.

The acoustic event beam to coverage area section association circuits, receiving an indication of an acoustic event from a specific beam event detection circuit, correlates the directional orientation parameters of the specific beam on which an event was detected to a coverage area sector indicative of the location of the acoustic source that triggered the detected event.

The location of the acoustic source that triggered the detected event is used by the response and notification circuits to generate and communicate, through the communication and interface circuits, user notifications including, or related to—the location of the event, and/or a data stream representing the audio signal that triggered the event, or part(s) thereof. Alternatively, or additionally, one or more event location based commands are generated and communicated to inform or direct one or more devices, systems and/or tools of/to the location of the detected event.

Reference is now made to FIG. 5, where there is shown, in accordance with some embodiments of the present invention, a block diagram of an exemplary structure of a four dimensional (4D) audio visual data packet, including system components associated with the generation of the data packet.

Audio and video data generated by an acoustic monitoring assembly based on audio and video signals it acquired from a coverage area of the system, is relayed to the shown packet generator. Relayed data includes: microphone sensor data, for example in form of a pulse-density modulation (PDM) digital/binary signal, from each of the microphones of the assembly; video stream data from a video camera of, or functionally associated with, the assembly; and respective configuration data.

The packet generator generates a data packet including: a start code, a time stamp indicative of the time-period at which the video and audio signals were acquired, the number of blocks included in the packet, and the actual data blocks

Each of the data blocks is shown to include a block type indicator selected from a set of different block types, including: a video block—for example, a motion-compensation-based video compression such as h.246 N; a sensor block—for example, 64 bit aligned PDM data; a configuration (config) block—for example, in the form of a configuration file data serialization language code, such as a YAML encoded array configuration; or an audio block—for example, in the form of an encoded single channel audio data. Each of the data blocks is shown to further include a block size indicator; and the data of the block in accordance with its type—video, sensor, config., or audio.

Reference is now made to FIG. 6A, where there is shown a functional block diagram of an exemplary system operated according to a first mode of operation, providing real-time audio scoping, in accordance with embodiments of the present invention.

In the figure, output data signals, of acoustic beams generated by the acoustic monitoring assemblies and/or by beams forming circuits of the system controller and data processor—are shown to be directly relayed, substantially in real time, from the beam forming circuits to the command and control interface terminals for user playback and/or to the event detection circuits for analyzing each of the output data signals for an indication of an acoustic event on one or more of the signals.

Reference is now made to FIG. 6B where there is shown a flowchart including the steps of an exemplary operating method corresponding to the first mode of operation, in accordance with embodiments of the present invention.

The flowchart exemplifies an operating method for real-time audio scoping and acoustic event detection, including the following steps: Acquiring acoustic signals from a set of microphone array assemblies monitoring a coverage area; relaying acquired raw signal data to a processing unit; aggregating received signal data; forming multiple acoustic directional beams across coverage area, calculating—inter-assemblies and intra-assemblies (array-mics)—time delay alignments—corresponding to the direction of each of the formed beams; processing each of the formed multiple acoustic directional beam output data signals—to detect an event(s) on a specific output signal(s) from within the formed beam signals. Upon detection of an event: associating the direction of the specific beam signal(s) on which an event(s) is detected with a portion/section of the coverage area; and generating and relaying one or more user notifications and/or device commands—associated-with/indicative-of the portion/section/sector of the coverage area associated with the event.

Reference is now made to FIG. 6C where there is shown a flowchart including the steps of an exemplary operating method corresponding to the first mode of operation, in accordance with embodiments of the present invention.

The flowchart exemplifies an operating method for real-time audio scoping and acoustic target surveillance, including the following steps: Acquiring acoustic signals from a set of microphone array assemblies monitoring a coverage area; relaying acquired raw signal data to a processing unit; aggregating received signal data. Upon receiving a command for acoustic surveillance: forming, on one or more of the assemblies, one or more acoustic directional beams oriented at the direction of an acoustic source target—within system coverage area—indicated in the received command; and relaying the output data signal of the formed acoustic target directed beam or a summed up output data signal derived from the multiple formed acoustic target directed beams for user playback.

Reference is now made to FIG. 7A, where there is shown a functional block diagram of an exemplary system operated according to a second mode of operation, providing recorded scene playback audio scoping, in accordance with embodiments of the present invention.

In the figure, raw output data signals, of acoustic beams generated by the acoustic monitoring assemblies—are shown to be initially logged to the system's data-storage/database by a raw signals data logger. The shown raw signals data retriever—upon receiving (at a later time) a user command, including specific time slot indicative parameters, from the command and control interface terminals—retrieves previously logged raw output data signals associated with the specified time slot. Retrieved raw output data signals are relayed to the monitoring-assemblies parallel-slot time alignment calculation circuits for time aligning raw output data signals, originating from different assemblies, based on coverage area location/direction parameters included in the received user command.

Inter assembly time aligned raw output data signals are relayed to playback circuitry for beam forming filter playback, wherein the beam forming filter is configured by its functionally associated configuration circuits, based on the coverage area location/direction parameters included in the received user command. The shown signal output circuits, relays the resulting acoustic beam output data signals for communication to command and control interface terminals for user playback

Similarly, multiple concurrent acoustic beams may be generated based on retrieved, previously logged, raw output data signals, wherein generated multiple acoustic beam output data signals are associated with the same past time slot. Generated acoustic beam output data signals may be each analyzed for acoustic event detection on one or more of the signals, as described herein, to derive the direction or specific location of an acoustic event that occurred, at the system's coverage area, within the designated past time slot of the retrieved raw output data signals.

Reference is now made to FIG. 7B where there is shown a flowchart including the steps of an exemplary operating method corresponding to the second mode of operation, in accordance with embodiments of the present invention.

The flowchart exemplifies an operating method for playback audio scoping and acoustic target surveillance, including the following steps: Acquiring acoustic signals from a set of microphone array assemblies monitoring a coverage area; relaying acquired raw signal data to a processing unit; logging received signal data over a time period. Upon receiving a playback audio scoping command: retrieving logged signals data matching time slot parameters in received scoping command, calculating—inter-assembly and intra-assembly (array-mics)—time delay alignments—based on direction parameters in received scoping command; playback(ing) retrieved and time aligned signals through a beam forming filter configured based on direction parameters in received scoping command; and relaying the beam forming filter output signal—for the requested time slot and direction—and/or triggering a related notification/command.

Reference is now made to FIG. 7C where there is shown a flowchart including the steps of an exemplary operating method corresponding to the second mode of operation, in accordance with embodiments of the present invention.

The flowchart exemplifies an operating method for playback audio scoping and acoustic event detection, including the following steps: Acquiring acoustic signals from a set of microphone array assemblies monitoring a coverage area; relaying acquired raw signal data to a processing unit; logging received signal data over a time period. Upon receiving an event detection command: forming multiple acoustic directional beams across coverage area using stored signal data associated with a time slot/period indicated in the received command, calculating—inter-assembly and intra-assembly (array-mics)—time delay alignments—corresponding to the direction of each of the formed beams; processing each of the formed multiple acoustic directional beam output data signals—to detect an event(s) within the command indicated time slot/period—on a specific output signal(s) from within the formed beam signals; associating the direction of the specific beam signal(s) on which an event(s) is detected with a portion/section of the coverage area; and generating and relaying one or more user notifications and/or device commands—associated-with/indicative-of the portion/section/sector of the coverage area associated with the event.

Reference is now made to FIG. 8A, where there is shown a functional block diagram of an exemplary system operated according to a third mode of operation, providing acoustic intelligence based threat and event detection, in accordance with embodiments of the present invention.

In the figure, an acoustic beam output data signal, on which an acoustic event has been detected as described herein, is relayed to the shown audio event classification circuits. The audio event classification circuits, correlate features/characteristics of the output data signal to stored audio event classes/types characteristics—classifying the type of detected event based on its matching/matching-level to characteristics of one or more of the stored event category/class/type. The classification decision may be alternatively reached, supported/verified and/or opposed/contradicted/challenged—by AI layer and/or rule set parameters analysis/processing of the output data signal, or parts, sections, segments and/or features thereof.

The shown event classification response/notification matching circuits uses the determined/estimated detected event classification result, to reference and retrieve stored response/notification options/actions/scenarios associated-with, or matching, the determined/estimated classification. The matching response/notification, or commands and/or information based thereof, is relayed for communication to the command and control interface terminals, to the video camera monitoring the system's coverage area, and/or to any other, functionally associated, device, tool, or system, as described herein.

Reference is now made to FIG. 8B where there is shown a flowchart including the steps of an exemplary operating method corresponding to the third mode of operation, in accordance with embodiments of the present invention.

The flowchart exemplifies an operating method for acoustic event classification and threat detection, including the following steps: Acquiring acoustic signals from a set of microphone array assemblies monitoring a coverage area; relaying acquired raw signal data to a processing unit; aggregating received signal data; forming multiple acoustic directional beams across coverage area, calculating—inter-assembly and intra-assembly (array-mics)—time delay alignments—corresponding to the direction of each of the formed beams; processing the multiple acoustic directional beam signals formed—to detect an event(s) on a specific signal(s) from within the formed beam signals. Upon detection of an event: associating the direction of the specific signal(s) on which an event(s) is detected with a portion/section of the coverage area; classifying the detected event(s) into an event type category(ies); retrieving a response/notification matching the category(ies) of the classified event(s); and generating and relaying the response/notification to a command and control interface terminal(s) and/or to a response unit(s) (e.g. a video surveillance camera directional commands).

The following, are descriptions of exemplary non-limiting device and assembly configurations, in accordance with some embodiments of the present invention:

According to some embodiments, an acoustic sampling device/assembly may comprise: a set/array of two or more microphones positioned at known locations relative to one another; a microphone sampling circuit comprising at least one electric power source, at least one clock signal generator, at least one signal input line per array microphone; and a microphone signal processor.

The device may further comprise a multichannel microphone data packetizer to produce a packet stream by inserting into a payload of at least one packet at least one audio sampling reference timestamp and microphone data from each of the two or more microphones having a bit-level time alignment relative to the at least one audio sampling reference timestamp.

According to some embodiments, an acoustic sampling device/assembly may comprise: a set/array of two or more microphones positioned at known locations relative to one another; a microphone sampling circuit comprising at least one electric power source, at least one clock signal generator; at least one signal input line per array microphone; and a microphone signal processor to generate a microphone array data stream including at least one audio sampling reference timestamp and microphone data from each of the two or more microphones having a bit-level time alignment relative to the at least one audio sampling reference timestamp.

The following, are descriptions of exemplary non-limiting system components, features and optional system component/feature combinations, in accordance with some embodiments of the present invention:

According to some embodiments, multiple concurrent acoustic beams from the same microphone assembly/array may be utilized to detect and localize specific acoustic events, their direction of occurrence in relation to the assembly/array and/or their location within a monitored coverage area.

According to some embodiments, two or more of the concurrent acoustic beams may be oriented at multiple different directions; beam output signals may be time aligned at the assembly; relayed to signal processing circuits; separately analyzed to detect an acoustic event; and the location of the detected event may then be associated with the direction at which the specific acoustic time aligned beam(s)—on which the event was detected—is/are oriented at.

According to some embodiments, the beams output signals may be analyzed substantially at real-time.

According to some embodiments, the beams output signals may be stored, and analyzed retrospectively.

According to some embodiments, the beams output signals may be further time aligned with a video stream.

According to some embodiments, time aligned segments of each of a set/array of beams output signals, and a video stream time segment aligned therewith, may be collectively encapsulated—into the same digital data packet—by the assembly, prior to their relaying to the signal processing circuits.

According to some embodiments of the present invention, multiple concurrent acoustic beams concurrently generated from each of two or more different assemblies/arrays may be utilized to detect and localize specific acoustic events. Two or more acoustic beams, for the same or from different assemblies/arrays, may be used to localize an acoustic event based on beams triangulation, beam crossing pin pointing and/or any other localization technique.

According to some embodiments, two or more concurrent acoustic beams, generated from two different assemblies, may overlap.

According to some embodiments, the multiple concurrent acoustic beams may be oriented at multiple different directions; beam output signals may be time aligned at each of the assemblies/arrays; relayed to signal processing circuits; acoustic beam sets output signals, generated by each of the different assemblies, may be time aligned; beams may be separately analyzed to detect an acoustic event; the location of the detected event may be associated with the direction at which a first specific acoustic time aligned beam from a first assembly—on which the event was detected—is/are oriented at; and the location of the detected event may be further associated with the position (e.g. pin pointed) at which at least a second specific acoustic time aligned beam from a first assembly—on which the event was detected—crosses-the/overlaps-with the first specific acoustic time aligned beam.

According to some embodiments, the beams output signals may be analyzed substantially at real-time.

According to some embodiments, the beams output signals may be stored, and analyzed retrospectively.

According to some embodiments, the beams output signals—of each of at least some of the assemblies/arrays—may be further time aligned with a video stream generated by the same assembly/array.

According to some embodiments, time aligned segments of each of a set of beams output signals, and a video stream time segment aligned therewith, may be collectively encapsulated—into the same digital data packet—by at least part of the assemblies/arrays, prior to their relaying to the signal processing circuits.

According to some embodiments of the present invention, multiple concurrent acoustic beams from the same assembly may be utilized to improve/boost fidelity of an acoustic signal source.

According to some embodiments, the multiple concurrent acoustic beams may be oriented at multiple different directions, wherein a first set of one or more of the beams are directed towards the acoustic signal source.

According to some embodiments, at least one beam out of a second set of one or more additional beams (of said multiple concurrent acoustic beams) overlaps with at least one of the beams from the first set—at, or at the proximity of, the acoustic signal source.

According to some embodiments, the at least one beam out of a second set of one or more additional beams (of said multiple concurrent acoustic beams) may be directed towards and sample background noise sources to generate noise subtraction signal(s).

According to some embodiments, beam output signals may be time aligned at the assembly; relayed to signal processing circuits; and separately analyzed to improve/boost fidelity of the acoustic signal source.

According to some embodiments, separately analyzed beam output signals may be utilized for improving/boosting fidelity of the acoustic signal source by adding multiple source signals from different beams.

According to some embodiments, separately analyzed beam output signals may be utilized for improving/boosting fidelity of the acoustic signal source by subtracting one or more generated noise subtraction signals from different beams, from one or more added source signals from different beams.

According to some embodiments, the beams output signals may be further time aligned with a video stream, and the acoustic signal source may be selected by user interfacing of a specific position over a frame of the video stream.

According to some embodiments, the beams output signals may be analyzed substantially at real-time.

According to some embodiments, the beams output signals may be stored, and analyzed retrospectively.

According to some embodiments of the present invention, multiple concurrent acoustic beams from each of two or more different assemblies/arrays may be utilized to improve/boost fidelity of an acoustic signal source.

According to some embodiments, the multiple concurrent acoustic beams may be oriented at multiple different directions, wherein a first set of one or more of the beams—from a first assembly—are directed towards the acoustic signal source.

According to some embodiments, at least one beam—from a second assembly—out of a second set of one or more additional beams (of said multiple concurrent acoustic beams) may overlap with at least one of the beams from the first set—at, or at the proximity of, the acoustic signal source.

According to some embodiments, at least one beam—from a second assembly—out of a second set of one or more additional beams (of said multiple concurrent acoustic beams) may be directed towards and sample background noise sources to generate noise subtraction signal(s).

According to some embodiments, beam output signals of each assembly/array maybe time aligned with each other at the assembly; relayed to signal processing circuits; and beam output signals of each assembly of the two or more different assemblies/arrays may be time aligned with beam output signals from each of the other assemblies at the processing circuits.

According to some embodiments, beams may be separately analyzed to improve/boost fidelity of the acoustic signal source.

According to some embodiments, separately analyzed beam output signals may be utilized for improving/boosting fidelity of the acoustic signal source by adding multiple source signals from different beams generated by at least two different assemblies/arrays.

According to some embodiments, separately analyzed beam output signals may be utilized for improving/boosting fidelity of the acoustic signal source by subtracting one or more generated noise subtraction signals from different beams generated by at least two different assemblies; from one or more added source signals from different beams generated by at least two different assemblies.

According to some embodiments, the beams output signals may be further time aligned with a video stream, and the acoustic signal source may be selected by user interfacing of a position over a frame of the video stream.

According to some embodiments, the beams output signals may be analyzed substantially at real-time.

According to some embodiments, the beams output signals may be stored, and analyzed retrospectively.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An acoustic sampling device comprising:
a set of two or more microphones positioned at known locations relative to one another;
a microphone sampling circuit comprising:
an electric power source;
a clock signal generator;
at least one signal input line per array microphone; and
a microphone signal processor;
and a multichannel microphone data packetizer to produce a packet stream by inserting into a payload of a data packet at least one audio sampling reference timestamp and microphone data from each of said two or more microphones having a bit-level time alignment relative to the at least one audio sampling reference timestamp.

2. An acoustic sampling device comprising:
a set of two or more microphones positioned at known locations relative to one another;
a microphone sampling circuit comprising:
an electric power source;
a clock signal generator;
at least one signal input line per array microphone; and
a microphone signal processor to generate a microphone array data stream including at least one audio sampling reference timestamp and microphone data from each of said two or more microphones having a bit-level time alignment relative to the at least one audio sampling reference timestamp.

3. A system to detect and localize specific acoustic events, said system comprising:
A microphone assembly having two or more microphones for generating multiple concurrent acoustic beams wherein two or more of the multiple concurrent acoustic beams are oriented at multiple different directions and the acoustic beams' output signals are time aligned at each of the assemblies and relayed to signal processing circuits;
Said signal processing circuits separately analyze the output signals to detect an acoustic event and to associate the location of the detected event with the direction at which the specific acoustic time aligned beam(s)—on which the event was detected—are oriented at.

4. The system according to claim 3, wherein the beams output signals are analyzed substantially at real-time.

5. The system according to claim 3, wherein the beams output signals are stored, and analyzed retrospectively.

6. The system according to claim 3, wherein the beams output signals are further time aligned with a video stream.

7. The system according to claim 3, wherein time aligned segments of each of a set of beams output signals, and a video stream time segment aligned therewith, are collectively encapsulated—into the same digital data packet—by said assembly, prior to their relaying to the signal processing circuits.

8. The system according to claim 3, wherein the multiple concurrent acoustic beams are concurrently generated from two or more different assemblies to detect and localize specific acoustic events by triangulation or pin-pointing of the multiple concurrent acoustic beams and wherein at least two of the beams are generated by two separate assemblies.

9. The system according to claim 8, wherein two or more of the concurrent acoustic beams, generated from two different assemblies, at least partially overlap.

10. The system according to claim 9, wherein two or more of the concurrent acoustic beams, generated from two or more of said different assemblies, are time aligned.

11. The system according to claim 10, wherein the concurrent acoustic beams are separately analyzed by said signal processing circuits to detect an acoustic event; and the location of the detected event is associated with the direction at which a first specific acoustic time aligned beam from a first assembly—on which the event was detected—is/are oriented at.

12. The system according to claim 11, wherein the location of the detected event is pin-pointed at a position at which at least a second specific acoustic time aligned beam from a second assembly—on which the event was detected—crosses the first specific acoustic time aligned beam.

13. The system according to claim 8, wherein the beams output signals—of each of at least some of the assemblies—are further time aligned with a video stream generated by the same assembly.

14. The system according to claim 13, wherein time aligned segments of each of a set of beams output signals, and a video stream time segment aligned therewith, are collectively encapsulated—into the same digital data packet—by at least part of the assemblies, prior to their relaying to the signal processing circuits.

15. The system according to claim 3, wherein multiple concurrent acoustic beams from the same assembly are utilized to improve fidelity of an acoustic signal source.

16. The system according to claim 15, wherein fidelity is improved by adding multiple source signals from different beams.

17. The system according to claim 15, wherein at least one beam out of said multiple concurrent acoustic beams, is directed towards and samples background noise sources to generate noise subtraction signals.

18. The system according to claim 17, wherein fidelity is improved by subtracting one or more generated noise subtraction signals from different beams, from one or more source signals from different beams.
